(19) United States
(12) Patent Application Publication
(10) Pub. No.: US 2012/0278310 A1
(43) Pub. Date: Nov. 1, 2012

(54) Collaborative Filtering Using a Spatial-Aware Social Graph

(75) Inventors: Grady F. Laksmono, Los Angeles, CA (US); Cyrus Shahabi, Irvine, CA (US)

(73) Assignee: UNIVERSITY OF SOUTHERN CALIFORNIA, Los Angeles, CA (US)

(21) Appl. No.: 13/456,088

(22) Filed: Apr. 25, 2012

Related U.S. Application Data
(60) Provisional application No. 61/479,659, filed on Apr. 27, 2011.

(51) Int. Cl. G06F 17/30

(52) U.S. Cl. 707/722; 707/E17.059

(57) ABSTRACT

This specification describes technologies relating to collaborative filtering, such as collaborative filtering using a spatial-aware social graph. In at least one aspect, a method includes: receiving data including objects related to a social graph; identifying a proper subset of the objects based on their relationships with respect to the social graph; applying one or more spatial queries against the proper subset of the objects; and using a result of the one or more spatial queries, applied against the proper subset of the objects, as a feature in a recommendation process. In another aspect, a system includes: a user interface device; and one or more computers configured and arranged to provide a user a recommendation, with respect to objects, based on social and spatial information for the user associated with a spatial-aware social graph.

### CROSS REFERENCE TO RELATED APPLICATIONS

This application claims the benefit of the priority of U.S. Provisional Application Ser. No. 61/479,659, filed Apr. 27, 2011 and entitled “Collaborative Filtering”.

### BACKGROUND

This specification relates to collaborative filtering based on social graphs. Collaborative filtering involves filtering data (typically large data sets) to identify patterns or information that can be used for further useful activities. In addition, in the context of filtering for user data, social network information can be used in combination with the main data to assist the filtering process.

### SUMMARY

This specification describes technologies relating to collaborative filtering, such as collaborative filtering using a spatial-aware social graph. Implementations of these technologies can allow computer systems to provide localized recommendations of objects that are related with the spatial-aware social graph and more likely to the user's interests.

Use of spatial queries as one of the features to filter objects localized to the user in a recommendation algorithm can improve the results produced by the recommendation algorithm. In contrast with existing practice, both spatial and social information can be taken into consideration in constructing a recommendation.

### BRIEF DESCRIPTION OF THE DRAWINGS

FIG. 1 shows a process of collaborative filtering, in accordance with an aspect of the preset invention.

FIG. 2 shows an example of a process to identify a proper subset of Objects based on their relationships with respect to a social graph, in accordance with an aspect of the present invention.

FIG. 3 shows examples of computer hardware with which the present invention can be implemented.

FIG. 4 shows an example of a system in which the present invention can be implemented.

### DETAILED DESCRIPTION

In some implementations, “friends” (e.g., as defined by a separate system) can be used as the objects that are related to the spatial-aware graph. However, in other implementations, queries can be applied to other types of objects. Moreover, in various implementations, additional feature parameters can be added to the recommendation algorithm.

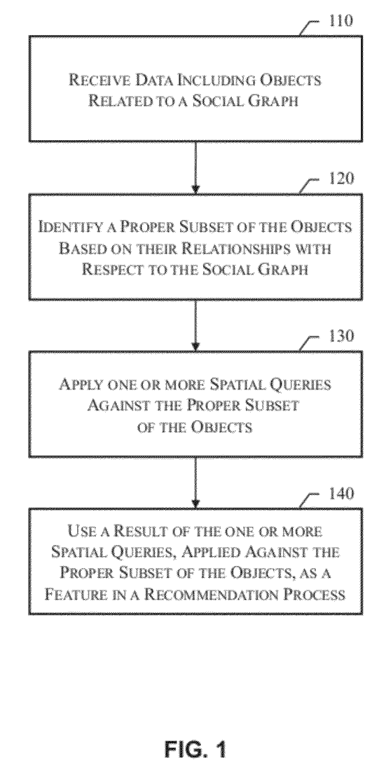

FIG. 1 shows a process of collaborative filtering, in accordance with an aspect of the present invention. Data is received, at 110, where the data includes objects related to a social graph. A proper subset of the objects is identified, at 120, based on their relationships with respect to the social graph. One or more spatial queries are applied, at 130, against the proper subset of the objects. Finally, a result of the one or more spatial queries applied against the proper subset of the objects can be used, at 140, as a feature in a recommendation process.

The term Object(s), as used herein, refers to any data that explicitly or implicitly have relationship to the spatial-aware social graph. For example, a user's friend is one of the Objects that is explicitly related to the user. But, upcoming events or places are implicitly related to the user. As soon as a user checks-in to the event or place, the user converts the implicit relationship to an explicit one. The spatial-aware social graph includes social graph data which contains geographical information about one or more of the data.

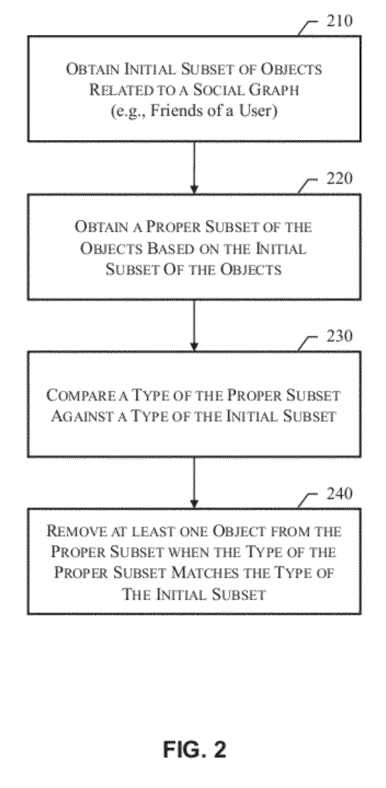

FIG. 2 shows an example of a process to identify a proper subset of Objects based on their relationships with respect to a social graph, in accordance with an aspect of the present invention. An initial subset of the objects can be obtained, at 210. For example, the objects can be friends of a user. The proper subset of the objects can then be obtained, at 220, based on the initial subset of the objects. A type of the proper subset can be compared, at 230, against a type of the initial subset. Then, at least one object can be removed, at 240, from the proper subset when the type of the proper subset matches the type of the initial subset.

In some implementations, the algorithm be as follows. 1. Get the user's friends (1st-degree friends, U_{F}). The system can be configurable to recursively find the N^{th}-degree friends, but 1^{st}-degree friends are generally used because of its close relatedness to the user. 2. Get the Union of the 1^{st}-degree Objects of U_{F} (2^{nd}-degree from the user, O_{C}). If the type of O_{C} is the same as U_{F}, make sure that all O_{C} are not in U_{F}.

Let the whole social graph be S. Let the 1^{st}-degree friends of the user is U_{F}={U_{F1}, U_{F2} . . . U_{FN}}⊂S. Let the Union of the 1^{st}-degree of U_{F}'s are O_{C}={O_{C11}, O_{C12} . . . O_{C/UF/M}}⊂S. If the type of O_{C} and U_{F} are the same, then Get O_{B}=O_{C}−U_{F}, O_{B}⊂S. If the type of O_{C} and U_{F} are not the same, then O_{B}=O_{C}⊂S.

3. Apply spatial queries against O_{B} and show all of its spatial attributes. In some implementations, the K-Nearest Neighbor (kNN) algorithm can be used, but this can also be configurable for Range, or any other commonly used spatial queries. See http:—download.oracle.com-docs-cd-B19306_{—}01-appdev.102-b14255-sdo_operat.htm, which is hereby incorporated by reference, for additional details regarding one or more algorithms that can be used in this context.

4. Use result(s) of the spatial queries as the feature for the recommendation algorithm. In some implementations, distance can be used as the main feature for recommendation, and the top K items can be picked. However, in some implementations, the system can be configured to consider additional features, such as the number of friend's check-ins. The function that is used to weight the score for recommendation can also be configurable.

The algorithm can run on a backend system and can communicate with the spatial databasc system that stores the spatial-award social graph. Sending a request to the backend system can result in the suggested objects being returned, which objects can be displayed on a front-end system.

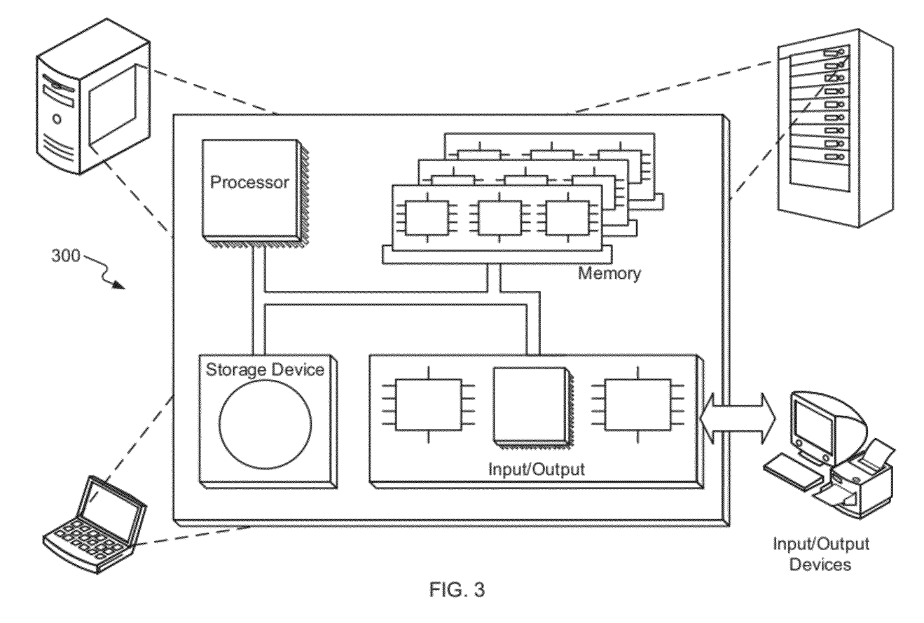

Embodiments of the subject matter and the functional operations described in this specification can be implemented in digital electronic circuitry, or in computer software, firmware, or hardware, including the structures disclosed in this specification and their structural equivalents, or in combinations of one or more of them. FIG. 3 shows examples of computer hardware 300 with which the present invention can be implemented. Embodiments of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more of them, and the computer-readable medium can provide the instructions to a processor by means of a signal, an artificially generated signal, e.g., a machine-generated electrical, optical, or electromagnetic signal, that is generated to encode information for transmission to suitable receiver apparatus for execution by a computer.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field program able gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System ((PS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

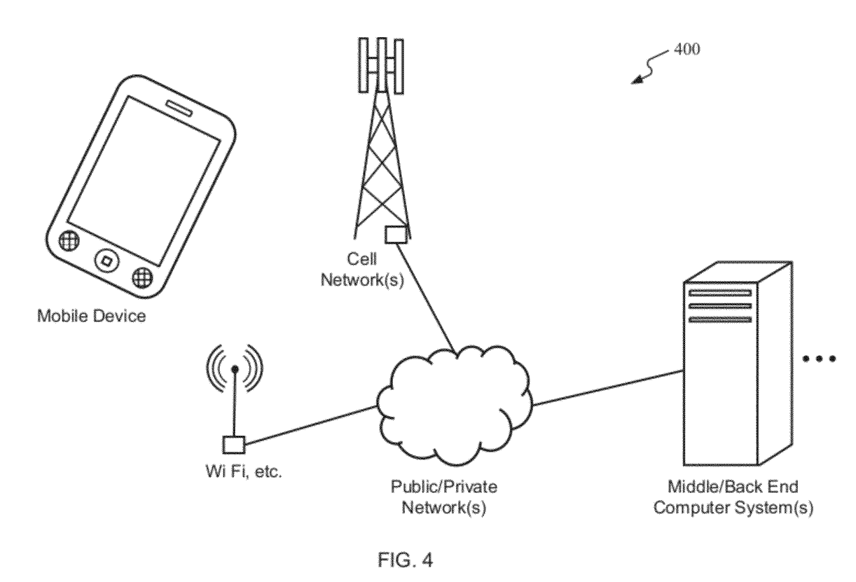

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. FIG. 4 shows an example of a system 400 in which the present invention can be implemented. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other.

White this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular embodiments of the invention have been described. Other embodiments are within the scope of the following claims. For example, the actions recited in the claims can be performed in a different order and still achieve desirable results.

What is claimed is:

1. A method comprising:
receiving data comprising objects related to a social graph;
identifying a proper subset of the objects based on their relationships with respect to the social graph;
applying one or more spatial queries against the proper subset of the objects; and
using a result of the one or more spatial queries, applied against the proper subset of the objects, as a feature in a recommendation process.

2. The method of claim 1, wherein the identifying comprises:
obtaining an initial subset of the objects;
obtaining the proper subset of the objects based on the initial subset of the objects;
comparing a type of the proper subset against a type of the initial subset; and
removing at least one object from the proper subset when the type of the proper subset matches the type of the initial subset.

3. The method of claim 2, wherein objects in the initial subset comprise friends of a user.

4. A computer program product, encoded on a computer-readable medium, operable to cause data processing apparatus to perform operations comprising:
receiving data comprising objects related to a social graph;
identifying a proper subset of the objects based on their relationships with respect to the social graph;
applying one or more spatial queries against the proper subset of the objects; and
using a result of the one or more spatial queries, applied against the proper subset of the objects, as a feature in a recommendation process.

5. The computer program product of claim 4, wherein the identifying comprises:
obtaining an initial subset of the objects;
obtaining the proper subset of the objects based on the initial subset of the objects;
comparing a type of the proper subset against a type of the initial subset; and
removing at least one object from the proper subset when the type of the proper subset matches the type of the initial subset.

6. The computer program product of claim 5, wherein objects in the initial subset comprise friends of a user.

7. A system comprising:
a user interface device; and
one or more computers operable to interact with the user interface device, the one or more computers comprising at least one processor and at least one memory device, and the one or more computers comprising means for collaborative filtering using a spatial-aware social graph.

8. The system of claim 7, wherein the one or more computers comprise a server operable to interact with the user interface device through a data communication network, and the user interface device is operable to interact with the server as a client.

9. The system of claim 8, wherein the user interface device comprises a mobile phone.

10. The system of claim 7, wherein the one or more computers comprises one personal computer, and the personal computer comprises the user interface device.

11. A system comprising:
a user interface device; and
one or more computers operable to interact with the user interface device, the one or more computers comprising at least one processor and at least one memory device, and the one or more computers configured and arranged to provide a user a recommendation, with respect to objects, based on social and spatial information for the user associated with a spatial-aware social graph.

12. The system of claim 11, wherein the objects comprise at least one object that has an implicit relationship to the spatial-aware social graph, but is not explicitly in the spatial-aware social graph.

13. The system of claim 11, wherein the one or more computers are configured and arranged to advance an object in the recommendation based on a current location of the user and the social information for the user.

14. The system of claim 11, wherein the one or more computers are configured and arranged to find up to an N^{th}-degree friends from the user in the spatial-aware social graph to provide the recommendation.

15. The system of claim 11, wherein the one or more computers are configured and arranged to user mathematical set theory to manipulate object utilization up to an N^{th}-degree from the user in the spatial-aware social graph to provide the recommendation.

16. The system of claim 11, wherein the one or more computers are configured and arranged to identify one or more spatial attributes of the objects using one or more spatial queries and use the one or more spatial attributes as one or more features in a recommendation process to provide the recommendation.
